(19) United States
(12) Patent Application Publication
(10) Pub. No.: US 2026/0112870 A1
(43) Pub. Date: Apr. 23, 2026

(54) Cable Aluminum Foil Stripping Tool, Aluminum Foil Stripping Device And Aluminum Foil Stripping Method

(71) Applicants: Tyco Electronics (Dongguan) Ltd., Dongguan City (CN); TE Connectivity Solutions GmbH, Schaffhausen (CH); Tyco Electronics (Shanghai) Co., Ltd., Shanghai (CN)

(72) Inventors: Zongjie (Jason) Tao, Shanghai (CN); Yi Li, Dongguan (CN); Hongzhou (Andy) Shen, Dongguan (CN); Dandan (Emily) Zhang, Shanghai (CN); Roberto Francisco-Yi Lu, Bellevue, WA (US)

(73) Assignees: Tyco Electronics (Dongguan) Ltd., Dongguan City (CN); TE Connectivity Solutions GmbH, Schaffhausen (CH); Tyco Electronics (Shanghai) Co., Ltd., Shanghai (CN)

(21) Appl. No.: 19/359,913

(22) Filed: Oct. 16, 2025

(30) Foreign Application Priority Data
Oct. 18, 2024 (CN) 202411464952.9

(51) Int. Cl. H02G 1/12

(52) U.S. Cl. CPC H02G 1/1297; H02G 1/1285

(57) ABSTRACT

The cable aluminum foil stripping tool includes two tool half-bodies adapted to clamp an exposed aluminum foil layer of a cable from two sides of the cable. Each tool half-body includes a body portion and a tooth-shaped rib formed on an inner side of the body portion and having a tooth-shaped cross section. The tooth-shaped rib scrapes off the exposed aluminum foil layer from the cable when the two tool half-bodies clamping the exposed aluminum foil layer are moved relative to the cable. The cable aluminum foil stripping tool includes an inner insulating layer wrapped by the exposed aluminum foil layer of the cable. The inner insulating layer is elastically deformable when contacting the tooth-shaped rib, such that the inner insulating layer is not scratched by the tooth-shaped rib.

### CROSS-REFERENCE TO RELATED APPLICATIONS

This application claims the benefit of the filing date under 35 U.S.C. § 119 (a)-(d) of Chinese Patent Application No. 202411464952.9, filed on Oct. 18, 2024.

### FIELD OF THE INVENTION

The present invention relates to a cable aluminum foil stripping tool, an aluminum foil stripping device, and an aluminum foil stripping method.

### BACKGROUND OF THE INVENTION

In the process of stripping an exposed aluminum foil layer of a cable, the exposed aluminum foil layer of the cable is first cut off with a cutting blade, and then the exposed aluminum foil layer is clamped with a clamp, and is shaken and pulled, such that the exposed aluminum foil layer is stripped off from the cable. This existing aluminum foil stripping method is prone to cutting into the inner insulation layer wrapped by the aluminum foil layer. Moreover, the existing aluminum foil stripping method has an excessively low pass rate, often not reaching ninety percent.

### SUMMARY OF THE INVENTION

The cable aluminum foil stripping tool includes two tool half-bodies adapted to clamp an exposed aluminum foil layer of a cable from two sides of the cable. Each tool half-body includes a body portion and a tooth-shaped rib formed on an inner side of the body portion and having a tooth-shaped cross section. The tooth-shaped rib scrapes off the exposed aluminum foil layer from the cable when the two tool half-bodies clamping the exposed aluminum foil layer are moved relative to the cable. The cable aluminum foil stripping tool includes an inner insulating layer wrapped by the exposed aluminum foil layer of the cable. The inner insulating layer is elastically deformable when contacting the tooth-shaped rib, such that the inner insulating layer is not scratched by the tooth-shaped rib.

### BRIEF DESCRIPTION OF DRAWINGS

In the following, the present invention is described in more detail with reference to the drawings in which:

FIG. 1 shows an illustrative exploded sectional view of a cable aluminum foil stripping tool and a cable according to an exemplary embodiment of the present invention;

FIG. 2 shows an illustrative assembly sectional view of a cable aluminum foil stripping tool and a cable according to an exemplary embodiment of the present invention;

FIG. 3 shows an illustrative exploded sectional view of a cable aluminum foil stripping tool and a cable according to another exemplary embodiment of the present invention; and

FIG. 4 shows an illustrative assembly sectional view of a cable aluminum foil stripping tool and a cable according to another exemplary embodiment of the present invention.

### DETAILED DESCRIPTION

Exemplary embodiments of the present disclosure will be described hereinafter in detail with reference to the attached drawings, wherein like reference numerals refer to like elements. The present disclosure may, however, be embodied in many different forms and should not be construed as being limited to the embodiments set forth herein; rather, these embodiments are provided so that the present disclosure will convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

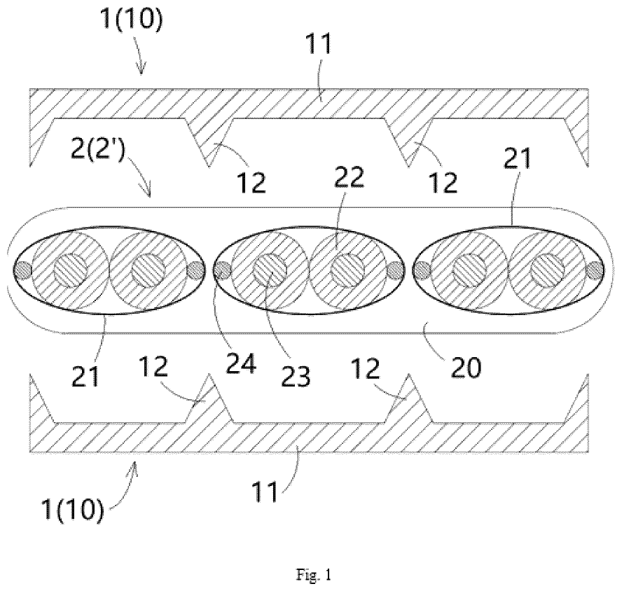

As shown in FIGS. 1 to 4, in an exemplary embodiment of the present invention, a cable aluminum foil stripping tool 1 is disclosed. The cable aluminum foil stripping tool 1 includes two tool half-bodies 10. The two tool half-bodies 10 are adapted to clamp an exposed aluminum foil layer 21 of a cable 2 from two sides of the cable 2. The tool half-body 10 includes a body portion 11 and a tooth-shaped rib 12 formed on an inner side of the body portion 11 and having a tooth-shaped cross section. The tooth-shaped ribs 12 scrape off the aluminum foil layer 21 from the cable 2 when the two tool half-bodies 10 clamping the aluminum foil layer 21 are moved relative to the cable 2. An inner insulating layer 22 wrapped by the aluminum foil layer 21 of the cable 2 is elastically deformable when coming into contact with the tooth-shaped ribs 12, such that the inner insulating layer 22 is not scratched by the tooth-shaped ribs 12.

As shown in FIGS. 1 to 4, in the illustrated embodiment, the tool half-body 10 is an integral part made of an elastic material, such that the tooth-shaped ribs 12 are elastically deformable when coming into contact with the inner insulating layer 22, to ensure that the inner insulating layer 22 is not scratched by the tooth-shaped ribs 12. In an exemplary embodiment of the present invention, the tool half-body 10 may be an integrally formed injection-molded part.

In the illustrated embodiment, when the aluminum foil layer 21 is clamped between the two tool half-bodies 10, the tooth-shaped ribs 12 extend by a predetermined length in an axial direction of the cable 2.

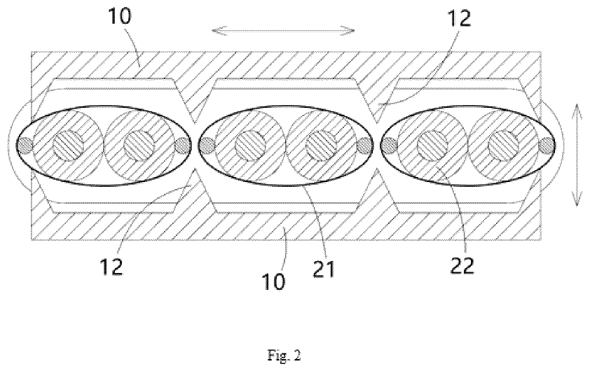

As shown in FIGS. 1 to 2, in the illustrated embodiment, the body portion 11 of the tool half-body 10 is a flat plate portion having a rectangular cross section, and the two tool half-bodies 10 are adapted to clamp the exposed aluminum foil layer 21 from two sides of a flat cable 2′ in a thickness direction to strip the exposed aluminum foil layer 21 of the flat cable 2′.

In the illustrated embodiment, in the process of stripping off the exposed aluminum foil layer 21 of the flat cable 2′, the tool half-body 10 vibrates back and forth in a width direction and the thickness direction of the flat cable 2′ to scrape off the exposed aluminum foil layer 21 of the flat cable 2′.

As shown in FIGS. 1 to 2, in the illustrated embodiment, a plurality of the tooth-shaped ribs 12 are formed on the inner side of the body portion 11 of the tool half-body 10, and the plurality of tooth-shaped ribs 12 are distributed at intervals in a width direction of the body portion 11 and extend in a length direction of the body portion 11.

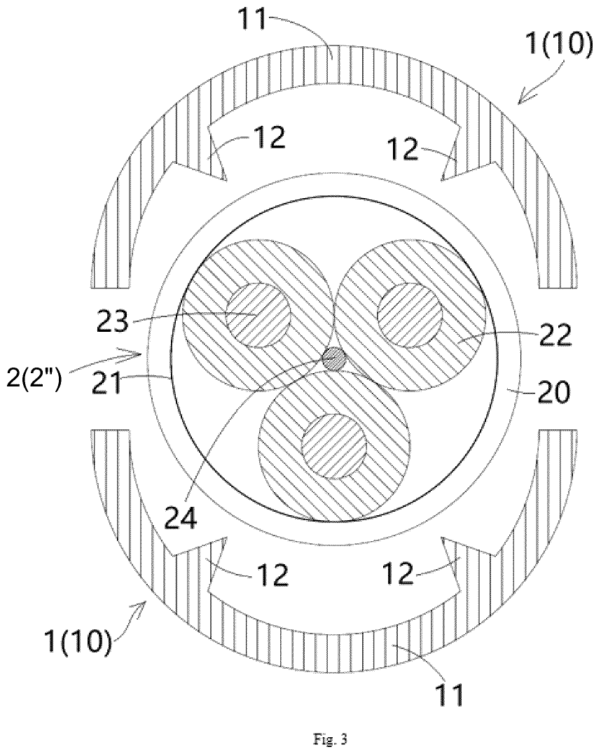

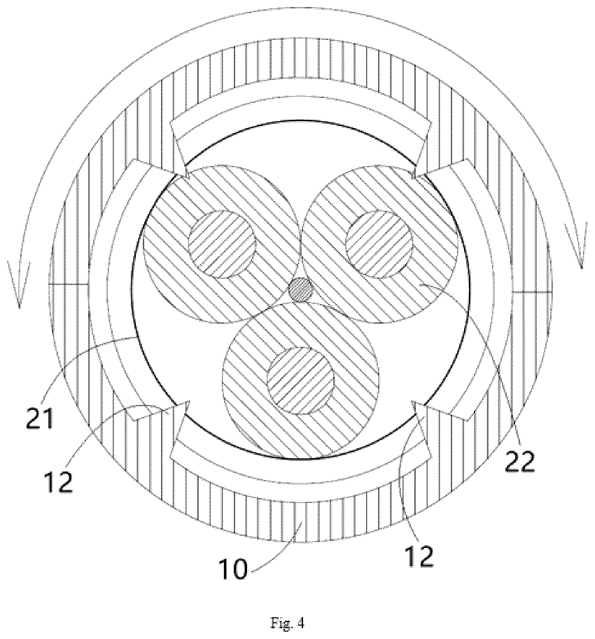

As shown in FIGS. 3 to 4, in the illustrated embodiment, the body portion 11 of the tool half-body 10 is a semi-cylinder having a semi-annular cross section, and the two tool half-bodies 10 are adapted to clamp the exposed aluminum foil layer 21 from two sides of a circular cable 2″ to strip off the exposed aluminum foil layer 21 of the circular cable 2″.

As shown in FIGS. 3 to 4, in the illustrated embodiment, in the process of stripping off the exposed aluminum foil layer 21 of the circular cable 2″, the tool half-body 10 vibrates back and forth in a circumferential direction of the circular cable 2″ to scrape off the exposed aluminum foil layer 21 of the circular cable 2″.

As shown in FIGS. 3 to 4, in the illustrated embodiment, a plurality of the tooth-shaped ribs 12 are formed on the inner side of the body portion 11 of the tool half-body 10, and the plurality of tooth-shaped ribs 12 are distributed at intervals in a circumferential direction of the body portion 11 and extend in an axial direction of the body portion 11.

As shown in FIGS. 1 to 4, in another exemplary embodiment of the present invention, an aluminum foil stripping device is disclosed. The aluminum foil stripping device includes the cable aluminum foil stripping tool 1, a clamp and a vibrator. The clamp is configured to clamp the two tool half-bodies 10 onto the exposed aluminum foil layer 21 of the cable 2. The vibrator is connected to the clamp. The vibrator is configured to drive the two tool half-bodies 10 to vibrate relative to the cable 2, to scrape off the exposed aluminum foil layer 21 of the cable 2 by the tooth-shaped ribs 12 on the tool half-bodies 10.

As shown in FIGS. 1 to 2, in the illustrated embodiment, the cable aluminum foil stripping tool 1 is configured to strip off the exposed aluminum foil layer 21 of a flat cable 2′. In the process of stripping off the exposed aluminum foil layer 21 of the flat cable 2′, the vibrator drives the two tool half-bodies 10 to vibrate back and forth in a width direction and a thickness direction of the flat cable 2′, as shown by the arrows.

As shown in FIGS. 3 to 4, in the illustrated embodiment, the cable aluminum foil stripping tool is configured to strip off the exposed aluminum foil layer 21 of a circular cable 2″. In the process of stripping off the exposed aluminum foil layer 21 of the circular cable 2″, the vibrator drives the two tool half-bodies 10 to vibrate back and forth in a circumferential direction of the circular cable 2″, as shown by the arrows.

As shown in FIGS. 1 to 4, in another exemplary embodiment of the present invention, an aluminum foil stripping method is disclosed. The aluminum foil stripping method includes the following steps:

S10: providing an aluminum foil stripping device as aforementioned;

S20: clamping the two tool half-bodies 10 onto the exposed aluminum foil layer 21 of the cable 2 by using the clamp; and

S30: driving the two tool half-bodies 10 to vibrate relative to the cable 2 by using the vibrator, to strip off the exposed aluminum foil layer 21 of the cable 2.

As shown in FIGS. 1 to 2, in the illustrated embodiment, the cable aluminum foil stripping tool 1 is configured to strip off the exposed aluminum foil layer 21 of a flat cable 2′. In the process of stripping off the exposed aluminum foil layer 21 of the flat cable 2′, the vibrator drives the two tool half-bodies 10 to vibrate back and forth in a width direction and a thickness direction of the flat cable 2′.

As shown in FIGS. 3 to 4, in the illustrated embodiment, the cable aluminum foil stripping tool 1 is configured to strip off the exposed aluminum foil layer 21 of a circular cable 2″. In the process of stripping off the exposed aluminum foil layer 21 of the circular cable 2″, the vibrator drives the two tool half-bodies 10 to vibrate back and forth in a circumferential direction of the circular cable 2″.

In the aforementioned exemplary embodiments according to the present invention, an aluminum foil layer of a cable can be stripped off with high efficiency and high quality without damaging an inner insulating layer of the cable.

It should be appreciated for those skilled in this art that the above embodiments are intended to be illustrated, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

What is claimed is:

1. A cable aluminum foil stripping tool, comprising:
a pair of tool half-bodies adapted to clamp an exposed aluminum foil layer of a cable from a pair of sides of the cable, each of the pair of tool half-bodies has a body portion and a tooth-shaped rib formed on an inner side of the body portion and having a tooth-shaped cross section, the tooth-shaped rib scrapes off the exposed aluminum foil layer from the cable when the pair of tool half-bodies clamping the exposed aluminum foil layer are moved relative to the cable; and
an inner insulating layer wrapped by the exposed aluminum foil layer of the cable, the inner insulating layer is elastically deformable when contacting the tooth-shaped rib and is not scratched by the tooth-shaped rib.

2. The cable aluminum foil stripping tool of claim 1, wherein each of the pair of tool half-bodies is an integral part made of an elastic material, the tooth-shaped rib is elastically deformable when contacting the inner insulating layer.

3. The cable aluminum foil stripping tool of claim 1, wherein, when the exposed aluminum foil layer is clamped between the pair of tool half-bodies, the tooth-shaped rib of each of the pair of tool half-bodies extends by a predetermined length in an axial direction of the cable.

4. The cable aluminum foil stripping tool of claim 1, wherein the body portion of each of the tool half-bodies is a flat plate portion having a rectangular cross section, the cable is a flat cable and the pair of tool half-bodies clamp the exposed aluminum foil layer from the pair of sides of the flat cable in a thickness direction to strip the exposed aluminum foil layer of the flat cable.

5. The cable aluminum foil stripping tool of claim 4, wherein, in a process of stripping off the exposed aluminum foil layer of the flat cable, each of the pair of tool half-bodies vibrates back and forth in a width direction and the thickness direction of the flat cable to scrape off the exposed aluminum foil layer of the flat cable.

6. The cable aluminum foil stripping tool of claim 5, wherein the tooth-shaped rib is one of a plurality of tooth-shaped ribs formed on the inner side of the body portion of each of the pair of tool half-bodies.

7. The cable aluminum foil stripping tool of claim 6, wherein the plurality of tooth-shaped ribs are distributed at intervals in the width direction of the body portion and extend in a length direction of the body portion.

8. The cable aluminum foil stripping tool of claim 1, wherein the body portion of each of the tool half-bodies is a semi-cylinder having a semi-annular cross section.

9. The cable aluminum foil stripping tool of claim 8, wherein the cable is a circular cable and the pair of tool half-bodies clamp the exposed aluminum foil layer from the pair of sides of the circular cable to strip off the exposed aluminum foil layer of the circular cable.

10. The cable aluminum foil stripping tool of claim 9, wherein, in a process of stripping off the exposed aluminum foil layer of the circular cable, the pair of tool half-bodies vibrates back and forth in a circumferential direction of the circular cable to scrape off the exposed aluminum foil layer of the circular cable.

11. The cable aluminum foil stripping tool of claim 9, wherein the tooth-shaped rib is one of a plurality of tooth-shaped ribs formed on the inner side of the body portion of each of the tool half-bodies.

12. The cable aluminum foil stripping tool of claim 11, wherein the plurality of tooth-shaped ribs are distributed at intervals in a circumferential direction of the body portion and extend in an axial direction of the body portion.

13. An aluminum foil stripping device, comprising:
a cable aluminum foil stripping tool including:
a pair of tool half-bodies adapted to clamp an exposed aluminum foil layer of a cable from a pair of sides of the cable, each of the pair of tool half-bodies has a body portion and a tooth-shaped rib formed on an inner side of the body portion and having a tooth-shaped cross section, the tooth-shaped rib scrapes off the exposed aluminum foil layer from the cable when the pair of tool half-bodies clamping the exposed aluminum foil layer are moved relative to the cable; and
an inner insulating layer wrapped by the exposed aluminum foil layer of the cable, the inner insulating layer is elastically deformable when contacting the tooth-shaped rib and is not scratched by the tooth-shaped rib;
a clamp configured to clamp the pair of tool half-bodies onto the exposed aluminum foil layer; and
a vibrator connected to the clamp, the vibrator drives the pair of tool half-bodies to vibrate relative to the cable.

14. The aluminum foil stripping device of claim 13, wherein the cable is a flat cable.

15. The aluminum foil stripping device of claim 14, wherein, in a process of stripping off the exposed aluminum foil layer of the flat cable, the vibrator drives the pair of tool half-bodies to vibrate back and forth in a width direction and a thickness direction of the flat cable.

16. The aluminum foil stripping device of claim 13, wherein the cable is a circular cable.

17. The aluminum foil stripping device of claim 16, wherein, in a process of stripping off the exposed aluminum foil layer of the circular cable, the vibrator drives the pair of tool half-bodies to vibrate back and forth in a circumferential direction of the circular cable.

18. An aluminum foil stripping method, comprising the following steps:
providing an aluminum foil stripping device including a pair of tool half-bodies each having a body portion and a tooth-shaped rib formed on an inner side of the body portion and having a tooth-shaped cross section; and
clamping the pair of tool half-bodies onto an exposed aluminum foil layer of a cable; and
driving the pair of tool half-bodies to vibrate relative to the cable by using a vibrator, the tooth-shaped ribs scrape off the exposed aluminum foil layer from the cable when the pair of tool half-bodies clamping the exposed aluminum foil layer are vibrated by the vibrator, an inner insulating layer wrapped by the exposed aluminum foil layer of the cable is elastically deformable when contacting the tooth-shaped ribs and is not scratched by the tooth-shaped ribs.

19. The aluminum foil stripping method of claim 18, wherein the cable is a flat cable and the vibrator drives the pair of tool half-bodies to vibrate back and forth in a width direction and a thickness direction of the flat cable.

20. The aluminum foil stripping method of claim 18, wherein the cable is a circular cable and the vibrator drives the pair of tool half-bodies to vibrate back and forth in a circumferential direction of the circular cable.
